(19) United States
(12) Patent Application Publication
(10) Pub. No.: US 2025/0290845 A1
(43) Pub. Date: Sep. 18, 2025

(54) SYSTEMS AND METHODS FOR SORTING USING LASER PARTICLES OR CELLS

(71) Applicant: The General Hospital Corporation, Boston, MA (US)

(72) Inventors: Seok-Hyun Yun, Cambridge, MA (US); Paul Dannenberg, Cambridge, MA (US)

(21) Appl. No.: 18/863,028

(22) PCT Filed: May 2, 2023
(86) PCT No.: PCT/US2023/066490

§ 371 Date: Nov. 5, 2024

Related U.S. Application Data
(60) Provisional application No. 63/339,491, filed on May 8, 2022.

(51) Int. Cl. G01N 15/1492; G01N 15/10; G01N 15/14

(52) U.S. Cl. CPC G01N 15/1492; G01N 15/1459; G01N 2015/1006

(57) ABSTRACT

A system and method for flow sorting includes a sample loader that is configured to receive a sample that contains one or more laser microparticles, wherein each laser microparticle is configured to generate laser emission with one or more distinct spectral peaks when excited. The system further includes a spectrometer receiving the laser emission from the one or more laser microparticle and generating spectral data and a processor configured to receive the spectral data and generate a sorting signal. The system also includes a switch configured to receive the sorting signal and route the one or more microparticles to a particular one of multiple collection channels based on the sorting signal.

### CROSS-REFERENCE TO RELATED APPLICATIONS

The present application is based on, claims priority to, and incorporates herein by reference in its entirety for all purposes, U.S. Provisional Application Ser. No. 63/339,491, filed May 8, 2022.

### BACKGROUND

The present disclosure relates to systems and methods for sorting using laser particles or cells. More particularly, the present disclosure provides systems and methods for identification of microparticles providing laser emission that may be used for sorting microparticles or cells, for example, in physical association with the microparticles based on the laser emission characteristics of the microparticles.

Flow sorters are widely used tools in numerous applications including life sciences, particularly for cellular analysis. A sorter is typically integrated with flow cytometry to analyze the biochemical and physical properties of cells or microparticles. Usually, the properties are measured by using fluorescent signals from each individual cell. Various active and passive sorting mechanisms are known, such as electrostatic droplet-based sorting, size-based separation, and inertial separation. This sorting technology is typically called Fluorescence-Activated Cell Sorting or “FACS.”

FACS are the most common types, which divert and collect cells into different vials based on the fluorescence signals related to immuno-stained biomarkers, viability, reporter-gene expressions, and etc. Light scattering-based sorting is also used for label-free purification of cell subpopulations such as lymphocytes and pancreatic islet cells. Magnetic-activated cell sorters (MACS) are also increasingly used to purify engineered cells for cell therapy. Fluorescence image-based cell sorting has recently been developed to enable selective isolation of single cells with unique spatial and morphological traits. In all these techniques, the sorting signals or routing decision are related to the cellular phenotypes measured in situ.

Laser particles (LPs) are micron- or submicron-sized particles capable of producing stimulated laser emission have become available. Upon optical excitation, or pumping, each LP emits radiation of sub-nanometer spectral linewidth providing an ultra-pure, distinguishable laser color. Recently demonstrated, semiconductor microdisk lasers represent LPs. With a wavelength interval of 1 nm, about 400 colors from 1200 to 1600 nm have been achieved, which could in principle be scaled to millions of barcodes by using combinations of LPs. These optical barcodes are well suited for tagging individual cells at large scales (>10,000 cells) for single-cell analysis.

Imaging such LPs and LP-tagged cells has been achieved by using a microscope integrated with a high-resolution optical spectrometer and a pump laser. This makes it possible to track LP tagged cells. Flow cytometers integrated with a spectrometer and a pump laser for reading LP barcodes have been demonstrated. However, flow sorters capable of sorting LPs and LP-tagged cells have not been available. Thus, the effective and efficient ability to leverage each of these techniques and systems eludes researchers.

### SUMMARY

The present disclosure provides systems and methods that overcome the aforementioned drawbacks by sorting laser particles based on their spectral emission characteristics. In one non-limiting configuration, a flow sorter is provided that is configured to route laser particles or cellular entities tagged with laser particles into multiple collection channels, wherein the decision for routing or sorting is based on the spectral emission characteristics of the laser particles in comparison to reference data serving as sorting criteria. The reference data can be used to collect the microparticles in one of the collection channels to share substantially similar barcoding characteristics in terms of lasing peak wavelengths, whereas these characteristics are substantially different from those of microparticles collected in a different output collection channel.

In accordance with one aspect of the present disclosure, a system is provided flow sorting that includes a sample loader that is configured to receive a sample that contains one or more laser microparticles, wherein each laser microparticle is configured to generate laser emission with one or more distinct spectral peaks when excited. The system further includes a spectrometer receiving the laser emission from the one or more laser microparticle and generating spectral data and a processor configured to receive the spectral data and generate a sorting signal. The system also includes a switch configured to receive the sorting signal and route the one or more microparticles to a particular one of multiple collection channels based on the sorting signal.

In accordance with another aspect of the present disclosure, a method for sorting laser microparticles is provided that includes loading a sample that contains one or more laser microparticles into a microfluidic system, exciting the one or more laser microparticles to cause each of the one or more laser microparticles to generate laser emission, and analyzing a spectrum of the laser emission to determine characteristics of the laser emission of each of the one or more laser microparticles. The method also includes, as each of the one or more laser microparticles progresses through the microfluidic system, sorting the one or more laser microparticles based on the characteristics to route each of the one or more laser microparticles with predetermined spectral characteristics to a common outlet of the microfluidic system.

These aspects are nonlimiting. Other aspects and features of the systems and methods described herein will be provided below.

### BRIEF DESCRIPTION OF THE DRAWINGS

The foregoing features of embodiments will be more readily understood by reference to the following detailed description, taken with reference to the accompanying drawings, in which:

FIG. 1 is a schematic diagram showing a schematic of the microfluidic setup using a high-voltage switch for sorting.

FIG. 2 is a block diagram showing a cell-sorting setup. A spectrometer reads the laser emission from laser particles. Decision hardware in a field programmable gate array (FPGA) triggers the computer to send high voltage pulses to electrodes to deflect cell-containing droplets into the (+) outlet.

FIG. 3A is a series of image frames showing a cell containing a single LP (arrow), as it traverses the pump laser focus (dashed ellipse), along with recorded spectra at the corresponding time.

FIG. 3B is a series of corelated graphs showing a narrow lasing peak observed on the spectrometer at the frame corresponding to the cell traversing this point in FIG. 3A.

FIG. 3C is a spectrum graph showing a collection of lasing spectra observed during a single experimental run.

FIG. 3D is a histogram showing recordings of lasing wavelengths from a near half million LPs measured in a single flow experiment.

FIG. 4A is a series of correlated images showing binary cell sorting to divide cells in populations with and without LPs. Image frames are shown of multiple droplets flowing through the sorting junction. Three successive droplets (i)-(iii) are labeled of which (ii) contains an LP-tagged cell and is thus deflected into the (+) outlet.

FIG. 4B is a set of correlated graphs showing the recorded spectra of the three droplets of FIG. 4A as they traverse the detection zone.

FIG. 5A is an image showing bright-field images of HeLa cells after sorting as collected from the (−) outlet.

FIG. 5B is an image showing bright-field images of HeLa cells after sorting as collected from the (+) outlet.

FIG. 5C is a graph showing a percent versus number of LPs at the starting sample.

FIG. 5D is a graph showing a percent versus number of LPs at the (−) channel.

FIG. 5E is a graph showing a percent versus number of LPs at the starting (+) channel.

FIG. 6A an illustration that depicts binary sorting where cells containing LPs are separated from those that do not.

FIG. 6B an illustration that depicts LP-based sorting where cells containing a pre-determined number of LPs are separated from those which do not contain that number of LPs.

FIG. 6C an illustration that depicts wavelength-based LP sorting of cells containing LPs.

FIG. 6D an illustration that depicts LP-based sorting using “multiplet” LPs.

FIG. 7A is an image that demonstrates short-wavelength sorting of a negative cell (λ>1450 nm) flowing into the (−) channel.

FIG. 7B is a graph that shows the LP emission spectrum of the negative cell of FIG. 7A. The shaded box indicates the gating condition used.

FIG. 7C is an image that demonstrates short-wavelength sorting of a positive cell (λ<1450 nm) directed into the (+) channel.

FIG. 7D is a graph that shows the LP spectrum of the positive cell of FIG. 7C. The shaded box indicates the gating condition used.

FIG. 8A is an imaging that demonstrates band-pass sorting of a bright-field image of replated cells collected from the (−) outlet.

FIG. 8B is graph that shows the LP lasing emissions from the LPs labelled i, ii and ii in FIG. 8A.

FIG. 8C is an image that demonstrates band-pass sorting of a bright-field image of replace cells collected from the (+) outlet.

FIG. 8D is a graph that shows the LP lasing emissions from the LPs labeled iv, v and vi) in FIG. 8C.

FIG. 9A is a perspective schematic diagram that illustrates a multi-angle light collection approach to collect laser emission from the microparticles effectively.

FIG. 9B is a perspective schematic diagram illustrates a magnetic alignment approach to collect laser emission from microparticles effectively.

FIG. 10A is an illustration that shows a technique to fuse two droplets, each of which contains only one cell or only one LP. Into one for cell tagging and combining multiple LPs.

FIG. 10B is an illustration that shows a technique to fuse two droplets, each of which contains only one LP.

FIG. 10C is an illustration that shows an image of two droplets containing single LPs.

FIG. 10D a set of correlated images that show a series of images of the experimental result of fusing two droplets at successive time points before, during and after fusion.

FIG. 11A is an schematic diagram that shows the first step of a re-circulating platform to produce multiple batches of laser microparticles or cells tagged with laser microparticles with specific spectral characteristics.

FIG. 11B is an schematic diagram that shows the second step of the re-circulating platform of LPs in droplet being moved into an alternat vial.

FIG. 11C is an schematic diagram that shows the third step of the re-circulating platform of LP droplet being sorted based on a reference spectral window in a collection vial.

FIG. 11D is an schematic diagram that shows a fourth step of the re-circulating platform, wherein unsorted LPs are reinjected into sorting device to be sorted using a different spectral collection window.

FIG. 12 shows an example of batch laser particles with substantially identical barcoding characteristics.

### DETAILED DESCRIPTION

Before the present invention is described in further detail, it is to be understood that the invention is not limited to the particular embodiments described. It is also to be understood that the terminology used herein is for the purpose of describing particular embodiments only and is not intended to be limiting. The scope of the present invention will be limited only by the claims. As used herein, the singular forms “a”, “an”, and “the” include plural embodiments unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements.

Flow cytometry is a technique that enables high-speed sequential analysis of the chemical and physical properties of cells or particles. Since the introduction of the earliest flow cytometer instruments in the 1950s, there has been significant development to commercialize the technique, in part by increasing the number of parameters and speed at which the instruments can detect. At the cutting edge, modern flow cytometers can perform measurements of close to 30 parameters on tens of thousands of cells each second. Usually, most of these parameters are fluorescent signals that are associated with each individual cell. A cell may exhibit a particular fluorescent color due to its intrinsic genetic protein expression (e.g., GFP labelled cells) or arising from the extrinsic introduction of a fluorescent marker.

Furthermore, flow cytometry can be coupled with an active sorting mechanism to select and isolate desired subpopulations particles or cells. In the case of cells this technique is termed fluorescence-activated cell sorting (FACS) and is routinely used to isolate desired cellular subpopulations. Multiple sorting mechanisms are possible. One of the most popular involves electrostatic, charge-based deflection of droplet-encapsulated cells into a specific outflow tract. Other active sorting mechanisms using acoustic waves, mechanical valves and magnetic forces have also been demonstrated.

To simultaneously discern multiple fluorescence colors, many high-end modern instruments must use numerous excitation and detection pathways often featuring as many as ˜5 distinct light sources, and as many as 40-60 separate photomultiplier tubes or avalanche photodiodes. Despite this complexity, a major drawback of fluorescence-based flow cytometry is the limited number of colors that can be detected due to spectral overlap arising from crosstalk between the different fluorophores. The broad spectral bandwidth of each fluorophore's emission results in spillover onto multiple PMT detectors. Despite the development of computational techniques to minimize the effects of this crosstalk, the number of colors that can be simultaneously measured remains limited. To simultaneously analyze a larger number of parameters, alternative techniques such as Cytometry by Time-Of-Flight (CyTOF) has also been developed that does not rely on color. Instead, heavy elements are used as tags and are subsequently identified by mass cytometry. However, though a large number of tags (>40) can be simultaneously used, the detection of these tags is inherently destructive, preventing further re-culture of the measured cells.

The present disclosure provides systems and methods for a flow sorter for separating cells or particles with specific characteristics. While conventional sorters use fluorescence signals from a sample to make decision about sorting, the disclosed sorter uses the spectral characteristics of laser emission from “laser particles.” Utilizing the systems and methods provided herein, the sorting decision is can be based on laser signals, which are different from fluorescence. Thus, using the systems and methods provided herein, laser particles can be used to represent an emerging, new type of barcodes well suited for identifying and tracking individual cells for single cell analysis.

The biological complexity of an organism arises from the diversity and interaction of individual cells. Optical imaging techniques with single cell resolution have played an invaluable role in developing an understanding of cellular identity and function. However, current imaging techniques, although widely used to distinguish several different cell populations, are not scalable to single cells at a large scale because they rely on fluorescent molecules with broad spectral emission that results in significant spectral crosstalk. In the present disclosure, intracellular optical probes called ‘laser particles’ (LPs) are presented, which can possess subnanometer spectral linewidth. This narrowband emission enables the generation of hundreds of unique colors well suited for cellular multiplexing. Using a top-down fabrication approach, a scalable method is developed to produce billions of micron-sized LPs from a single semiconductor wafer. Moreover, the design of the particles is refined by perturbing their optical modes using nano-scatterers to optimize their emission signal. Physically combining multiple LPs enables scaling the number of unique optical barcodes from hundreds to tens of thousands. Using these LP barcodes, thousands of mammalian cells are tagged and their barcode emissions are read out using a modified microscope and a custom-developed flow cytometer. The present disclosure offers a platform to identify single cells in various single-cell measurements and allows the acquired data of same cells to be integrated using the optical barcodes.

Laser particles include a class of cell tag that can be used to enable even higher degrees of multiplexing. As will be described “laser particle” or an “LP” can refer to a microparticle capable of emitting coherent light when inquired by a suitable excitation. The output spectrum can be discrete narrowband laser lines, which are typically related to the particular geometry and composition thereof. In this way, as will be described, this can serve as an optical barcode of the cellular entity associated with the laser particle. As a few non-limiting example, LP may include oligonucleotides, drugs, or other molecules in physical association with the microparticle. A “microparticle” can refer to a three-dimensional particle with a size, as one example, typically smaller than 100 μm. A particle having a size of 10 nm is still a “microparticle” in this context, because it has a size smaller than 100 microns. A “cellular entity” may include a cell, or a part of a cell, such as a nucleus, vesicle or organelle, or a coherent organization of cells, such as tissue and multicellular spheroid. The cellular entity may be live or chemically fixed. To “tag” a cellular entity can include causing one or more barcoding particles to be physically associated with the cellular entity. For cells, tagging may be achieved by attaching the barcoding particle(s) on the cell membrane or inserting the particle(s) into the cytoplasm. A “physical association” between an oligonucleotide and a laser particle and between a cellular construct and cellular entity can be established, for example, using a structural agent. The structural agent may include, for example, direct chemical bonding, a linker, encapsulation, and any other of a wide variety of physical confinement. Two physically associated items are in proximity with each other, for example, although not necessarily, within 100 nm or in some cases within 10 nm or less.

Upon optical excitation, known as pumping, each LP emits radiation of subnanometer spectral linewidth. Numerous types of LP have been demonstrated including semiconductor-based microdisk LPs comprised of alloys of group III and group V materials such as In₁₋ₓGaₓAs_{y}P_{1-y}. In a non-limiting example, these disk-shaped particles may have a diameter of approximately 2 μm and thickness of 0.2 μm. The diameter of each LP determines the emission wavelength of its lasing peak. LPs of different diameter can each emit their own narrowband radiation within a 100 nm spectral gain bandwidth whose span is dependent on the precise In₁₋ₓGaₓAs_{y}P_{1-y} material composition. Therefore, to further increase the number of colors, multiple spectrally offset gain bandwidths can be used, each of which is derived from a specific combination of x and y corresponding to a particular In₁₋ₓGaₓAs_{y}P_{1-y} composition. By reading the signal of an LP within a fluidic system, high speed analysis can be performed and augmented by manipulations of the particle and possibly of an associated cell.

In a non-limiting example, LP-based flow cytometry capable of simultaneous detection of more than 500 simultaneous laser colors is described. A single excitation source and a single optical detection pathway in which the emission color is determined using a high-resolution custom-built spectrometer is used.

In a non-limiting example, Laser Particle Activated Cell Sorting (LACS) at rates capable of exceeding 1 kHz is described. By sorting based on LP lasing emission, cells containing LPs of a particular wavelength can be isolated, ultimately creating a batch of LP-containing-cells in which most of these tags lase within a narrow ±2.5 nm spectral window, offering a degree of spectral purity that exceeds that achievable using fluorescence. Fluidic manipulations of LPs within microchannels are also described that further enhance their readout or allow the performance of operations that manipulate these LPs at high speeds.

In a non-limiting example, another embodiment is comprised of a similar system but is configured to sort laser particles without being tagged to cells or cellular entities.

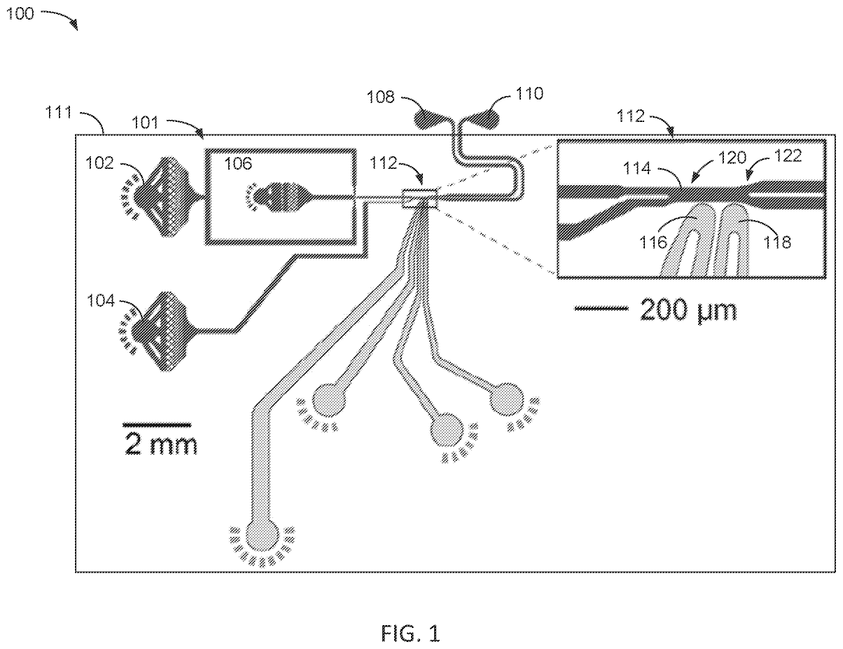

FIG. 1 shows a non-limiting example schematic of a two-way microdroplet sorting device 100 using dielectrophoresis, according to aspects of the present disclosure. The device 100 includes a sample loader 101. In one configuration, the sample loader 101 may include a droplet oil inlet 102, a spacer oil inlet 104, and cell inlet 106 as well as an (−) outlet 108 and a (+) outlet 110. The sample loader 101 may also be configured to deliver cells suspended in media that are flowed into the cell inlet 106. Also re-circulator 111 configured to feed one or more laser microparticles routed to the sample loader 101.

In a non-limiting example, a fluorinated oil immiscible with the aqueous cell media are flowed into the droplet oil inlet 102 and spacer oil inlet 104. The droplet oil inlet 102 pinches the aqueous flow, generating 50 μm diameter aqueous droplets. The spacer oil inlet 104 spaces the droplets at intervals of approximately 500 μm to ensure that each droplet is independently sorted. A central sorting zone 112 has a channel 114 whose width and depth may be 55 μm and 25 μm, respectively, and a mean flow speed of 0.5 m/s. Droplets may enter the flow channel 114 at a rate of approximately 1.5 kHz, or greater, such as 2 kHz, or even 10s of kHz. The device 100 further includes a pair of microelectrodes 116 and 118 offset from the proximal sidewall of the flow channel 114.

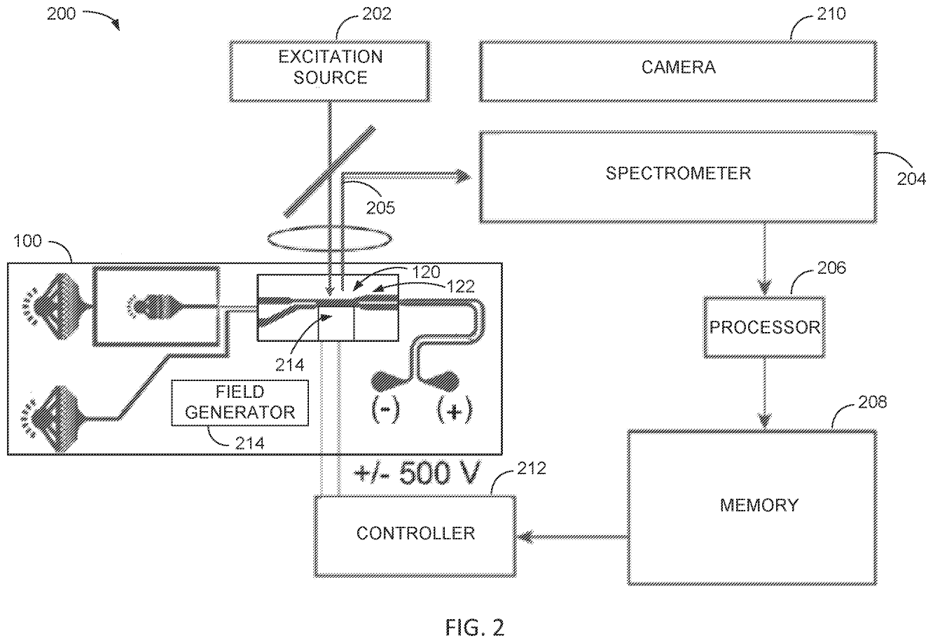

FIG. 2 shows a non-limiting example of a system 200 for sorting using the device 100 of FIG. 1. The system 200 includes an excitation source 202, which in some non-limiting examples may include a pump laser. The system 200 also includes a spectrometer 204 that, as will be described, is configured to receive emissions from the system of FIG. 1. In one non-limiting example, multiple optical fibers 205 may be configured to receive the laser emission from the one or more laser particles in different directions and transmit the laser emission to the spectrometer 204. A camera 210 may be included. The system 200 also includes a processor 206. As will be described, the process 206 may take any of a variety of forms, including a logic gate, such as a field programmable gate array (FPGA) or other architecture that processes the spectra for sorting. The system 200 may further include a memory 208. The memory 208 may be data acquisition (DAQ) system or card coupled to a controller 212 and switch 214. In some configurations, the processor 206, memory 208, and controller 212 may be integrated. Further, the system 200 may include a magnetic field generator 216 configured to apply a magnetic field to the one or more laser microparticles.

Referring to FIGS. 1 and 2, the excitation source 202 can be focused upstream 120 of a sorting junction 122, to register an LP emission signal. During operation, data from the spectrometer 204 can be communicated, for example, streamed in real time, to the processor 206 that processes the spectra for sorting. The processor 206 can first determine whether the intensity value of any pixel exceeds the threshold defined by the camera noise floor and applies pre-programmed gating criteria to decide between “sort (+)” and “no-sort (−)”. In the event that the criteria are met, the processor 206 can send the data to the memory 208, which is accessed by the controller 212 to, thereby, control the switch 214 to effectuate sorting. As will be described, the switch may be configured to effectuate acoustic sorting, valve-based routing, and inertial separation, or other electromagnetic, or physical sorting. As described above, the processor 206, memory 208, and controller 212 may be separate components or may be physically or functionally integrated.

In one non-limiting example, the processor 206 can send transistor-transistor logic (TTL) pulse to a data acquisition (DAQ) card triggering it to output a pulse train for a predetermined duration. For example, the output may be a 30 kHz square wave pulse train for a 400 μs duration. The flow rates can be set such that the traversal time of the LP through the detection zone is approximately comparable to the 30 μs exposure time of the camera 210 or other data acquisition device, such that individual LP spectra are read in only one or two frames.

In one configuration, a square wave pulse train can be fed to the controller, which may be a high voltage amplifier, which sends a 1 kV pk-pk voltage to a pair of microelectrodes 116, 118 operating as the switch 214. The voltage may be offset by 15 μm from the proximal sidewall of the flow channel 114. The electric field can apply a bound charge to the aqueous droplet since it has a higher permittivity than the surrounding oil. The droplet is then attracted by the electrode via Coulomb interaction, deflecting it into the desired outflow channel connected to the “sort (+)” outlet 110. This mechanism is known as dielectrophoresis.

The “no-sort (−)” flow channel can be shorter in light. In one non-limiting example, the (−) flow channel can be approximately 5% shorter in length, offering lower resistance pressure than the sorting channel. As a result, when the electrodes 116, 118 remain off, cells passively flow in the lower-pressure path and are collected in the “no-sort (−)” outlet 108. In a non-limiting example, the specific sorting junction 122 geometry includes a gapped divider that occupies part of the channel height and acts to further push the droplets toward either the (+) or (−) outlet.

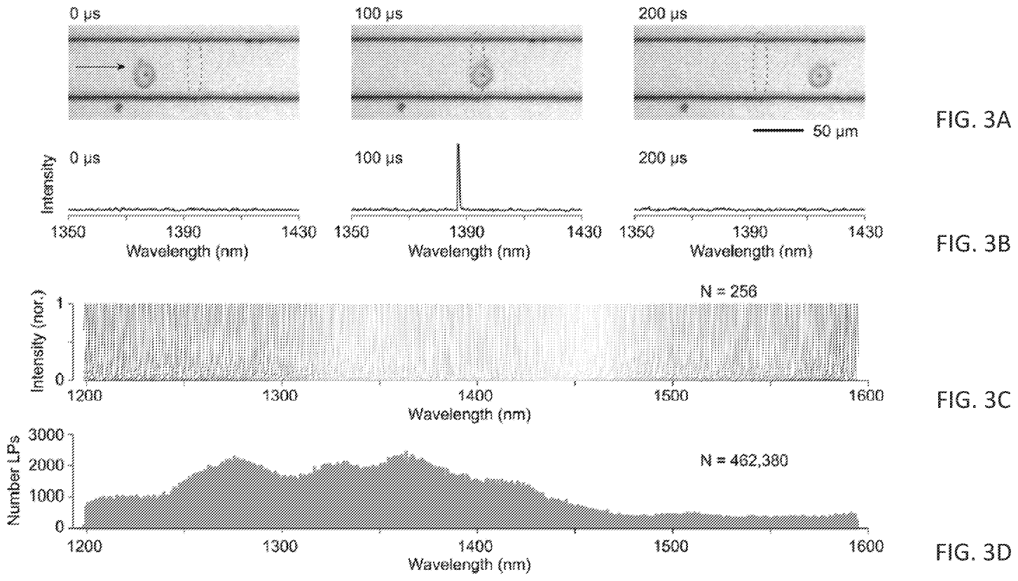

FIGS. 3A-2B illustrate a non-limiting example of the detection of laser emission from a laser particle in a microfluidic chip. FIG. 3A shows example high-speed video images (14 μs exposure, 10 k frames per second) of a droplet containing a cell tagged with a single semiconductor disk laser with a size of 2 μm is flowed through a channel, in which the pump light source is illuminated onto a portion of a microfluidic channel. Detection optics collects light emitted from the particle as it flows through the readout region. A distinct signal is observed on a few pixels of the spectrometer's linescan camera corresponding to a wavelength, in this case, of 1387 nm (FIG. 3B). The recorded linewidth δλ was 0.72 nm full width at half maximum (FWHM), limited by the spectrometer resolution. Importantly, this narrow linewidth means that the detection system can easily identify and resolve large numbers of laser colors. FIG. 3C shows 256 representative recorded spectra from 256 LPs across a bandwidth Δλ of ˜400 nm from 1200 nm to 1600 nm, the detection range of the spectrometer. FIG. 3D shows the histogram of over 460000 LPs across the bandwidth. The distribution itself reflects the diameters of the recorded LPs.

In this example, the laser particle is tagged into a cell, but laser particles may not be encapsulated inside or attached to a cell. The detection optics will frequently comprise of a spectrometer which can record the wavelength of the lasing spectrum. However, for certain specific applications, a photomultiplier tube could be used with detection bandwidth covering the expected wavelength range of the LPs. In this example, a 1 cm long straight-channel (width×depth=50 m×25 μm) was constructed using a PDMS-on-glass microfluidic chip. The microfluidic chip could then be positioned atop a microscope stage, with a 1064 nm pulsed (40 mW, 10 ns pulse width, 2 MHz repetition rate) pump laser focused within the channel center. By introducing a cylindrical lens before the objective, the pump laser focus was shaped into a roughly (10 m×50 m) line, covering the entire 50 μm channel width. Detection of spectral signals were performed by collecting light of emission wavelength 1100-1500 nm, which was directed into a homebuilt grating-based spectrometer (resolution 0.5-1.0 nm) equipped with a 2048-pixel linescan camera running at a speed of 29,000 lines/per second. Unlike most previous work on spectral flow cytometry (including recent commercial devices), a great benefit of semiconductor microdisk LPs is the requirement of only a single laser pump source. Since semiconductor LPs absorb any wavelength of light below that of the particle material's bandgap, lasing is achievable as long as x and y are chosen such that the bandgap of In₁₋ₓGaₓAs_{y}P_{1-y} is smaller than 1.17 eV (corresponding to 1064 nm free space wavelength). Secondly, the use of a high speed linescan camera detector enables far greater sampling of the detected wavelength, particularly compared to common approaches using multiple optical filters along with photomultiplier or avalanche photodiode arrays.

In a non-limiting example, cells suspended in cell media were injected into one end of the straight channel microfluidic flow device at a flow rate of approximately 40 μL/min, corresponding to a characteristic linear speed of approximately 0.5 m/s within the flow channel. Although some cells travelled at slightly different speeds, each cell traversed the pump's excitation spot in a time comparable to that of the camera exposure (30 μs). As the LP-tagged cell traverses the pump excitation, a distinct signal is clearly observed on a few pixels of the spectrometer's line scan camera corresponding to a wavelength, in this case, of approximately 1390 nm. The narrow 6k=0.72 nm FWHM linewidth arises from coherent emission from the LP. The peak wavelength at which this lasing occurs is predominantly determined by invariant quantities: the In₁₋ₓGaₓAs_{y}P_{1-y} material composition and the cavity's physical dimensions. Therefore, the value of peak wavelength can act as a signature of far reduced complexity to the complete emission profiles that are often recorded during non-LP based spectral flow measurements. Importantly, this narrow linewidth means that the detection system can easily identify and resolve large numbers of laser colors in a single experiment.

In a non-limiting example, approximately 500,000 LP-tagged cells were flowed through the straight microfluidic channel over a time period of 25 minutes. By using 9 distinct compositions of In₁₋ₓGaₓAs_{y}P_{1-y} ranging from (x=0.26, y=0.55) to (x=0.44, y=0.95), lasing across a bandwidth of Δλ=400 nm from 1200 nm to 1600 nm was observed, limited by the detection range of the spectrometer. A simplified, theoretical analysis suggests that the LP-based flow cytometer can thus independently resolve a maximum of approximately Δλ/δλ≈550 colors. Additionally, analysis of alternative parameters can be performed within the same cytometry channel. For example, fluorescence readout can also be performed or morphological traits, gathered via imaging-flow cytometry, can be collected. This information can be associated with the spectral signal of the LP.

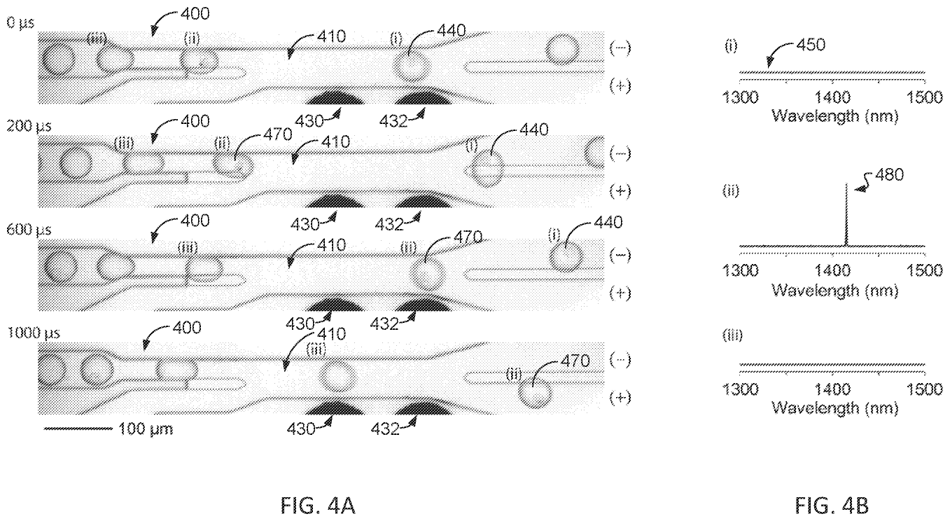

FIGS. 4A-4B show a non-limiting example of binary sorting based on the presence and absence of laser emission from microparticles. Cells are mixed with LPs and cultured overnight. Thereafter, approximately 35,000 cells (containing 25,000 LPs) are taken out of the cell culture and suspended in aqueous cell culture media. The cell sample is fed into the sorting device with a gating criterion that sends a high voltage pulse when any single lasing peak is detected above the noise floor. Cells are flown into a microfluidic channel through an input channel 400. The optical pumping is provided in the location 410 before the sorting switch electrodes 430 and 432. The sorting switch electrodes 430 and 432 may include the microelectrode pairs 116 and 118 of FIG. 1 The flow rates are set such that the traversal time of the LP through the detection zone is approximately comparable to the 30 μs exposure time of the camera such that individual LP spectra are read in only one or two frames.

Droplets that do not contain laser particles generate spectral data with no well-defined lasing peaks above the detection noise floor of the spectrometer, such as cell 440 in FIG. 4A. The lack of lasing peaks in its spectral data 450 in FIG. 4B results in no trigger signal. As a result, the droplet containing it is routed to a “no-sort (−)” collection channel. The no-sort flow channel is 5% shorter in length than the “sort (+)” flow channel, offering lower resistance pressure than the sorting channel. As a result, when the electrodes remain off, cells passively flow in the lower-pressure path and are collected in the (−) outlet.

On the other hand, for a cell 470 in FIG. 4A that is tagged with a laser particle produces a well-defined lasing peak in its spectral data 480 in FIG. 4B. This triggers the sorting switch, and the electric field applies a bound charge to the aqueous droplet since it has a higher permittivity than the surrounding oil. The droplet is then attracted by the electrode via Coulomb interaction, deflecting it into the desired collection channel connected to the (+) outlet.

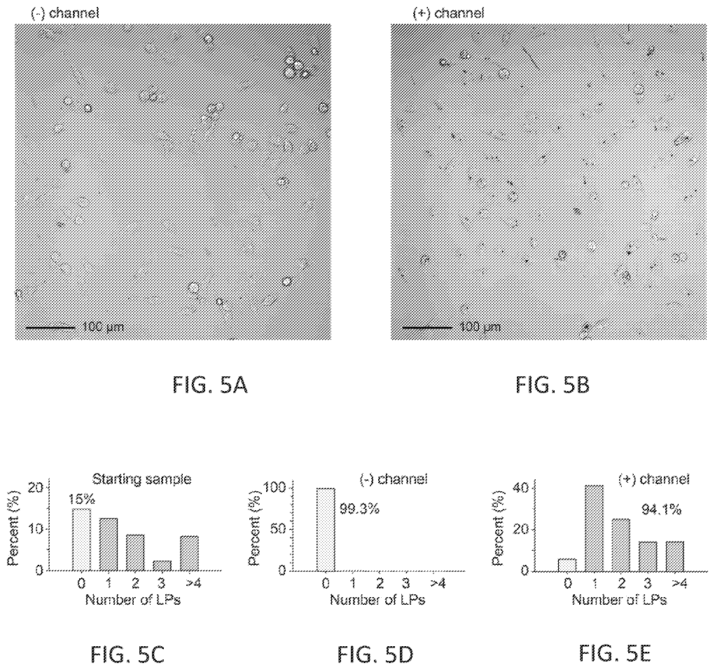

This non-limiting example of binary LP sorting route LP-containing cells separately from unbarcoded cells that do not contain LPs. In this example, HeLa cells were used, which were mixed with semiconductor microdisk LPs and cultured overnight. The next day, approximately 35,000 cells (containing approximately 25,000 LPs) were taken out of the cell culture and suspended in cell media. The cell sample was fed to the setup for sorting with a gating criterion that sends a high-voltage pulse when any single lasing peak is detected above the noise floor. The collected cell samples in the (−) and (+) outlets were replated separately and imaged 4 h after sorting. FIGS. 5A-5B shows these cells.

For comparison, prior to taking the cell sample from the original culture, the relative distribution of LPs within cells roughly followed a Poisson distribution (FIG. 5C). Binary sorting produced a stark difference in the relative distributions of LPs within cells (FIGS. 5D-5E. In the (+) outlet sample, 94.1% of cells contained 1 or more LPs. By contrast, the (−) outlet sample was almost disk free, with 99.3% of cells containing no disks.

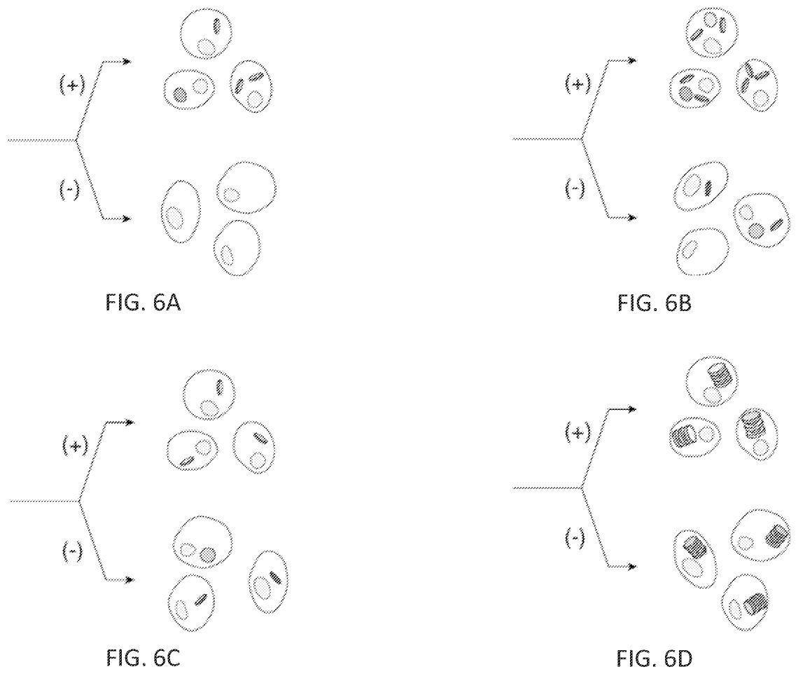

Numerous types of LACS are possible, as shown in FIGS. 6A-6D. FIG. 6A depicts the binary sorting demonstrated in the previous examples, where cells containing LPs are separated from those that do not. Since LPs can be used to track mammalian cells in studies of tumor invasion and migration, such a sorting operation could be used to isolate a subpopulation of trackable cells. Alternatively, LP tags have been proposed as single cell sequencing probes, in which the emission signatures allow individual cells to be tracked through an RNA sequencing workflow to enable knowledge of each cell's spatial location to be tied to information regarding its genetic expression. In some single cell sequencing protocols, cells are commonly sorted prior to sequencing, by traditional FACS, to target a desired subpopulation to be sequenced. Similarly, this type of LACS sorter would be able to enrich for cells suitable for sequencing by selecting tagged cells.

FIG. 6B shows a similar type of sorting in which cells containing a pre-determined number of LPs are separated from those which do not contain that number of LPs. For example, the (+) outlet contains cells that contain 3 LPs, and the (−) outlet contains cells that do not contain 3 LPs. Importantly since each cell in the (+) outlet is tagged by 3 LPs, each cell would contain a unique spectral barcode that would not be achievable using fewer LPs. Furthermore, it might be desirable to remove cells that contain too many LPs which might negatively affect their natural behavior.

FIG. 6C demonstrates wavelength-based LP sorting. This can isolate a population of LPs or LP-tagged cells with a very specific emission spectrum. This could be used to create monoclonal batches of high purity spectral emitters whose emission bandwidth is far narrower than that of a fluorescence emitter. For example, an LP sorting system could be used to isolate LPs or LP-tagged cells with emission properties spanning a nanometer spectral range as opposed to the tens of nanometer FWHM emission properties of fluorescent emitters. Alternatively, the sorting functionality could be used to remove particles with poor optical performance (e.g., wide spectral linewidth or low intensity).

FIG. 6D illustrates sorting using “multiplet” laser particles. A multiplet is an LP that emits laser light emission at multiple lasing wavelengths, allowing them to exhibit thousands or more unique spectral barcodes. Specific multiplets could be sorted and isolated based on their spectral data. Therefore, a user could specifically determine which cells to isolate based on each cell's unique multiplet barcode. Such a sorter could utilize a pre-computed look-up table to map sorting decisions. Therefore, when a particular spectrum is seen by the spectrometer, only a query in the table is needed to make a sorting decision.

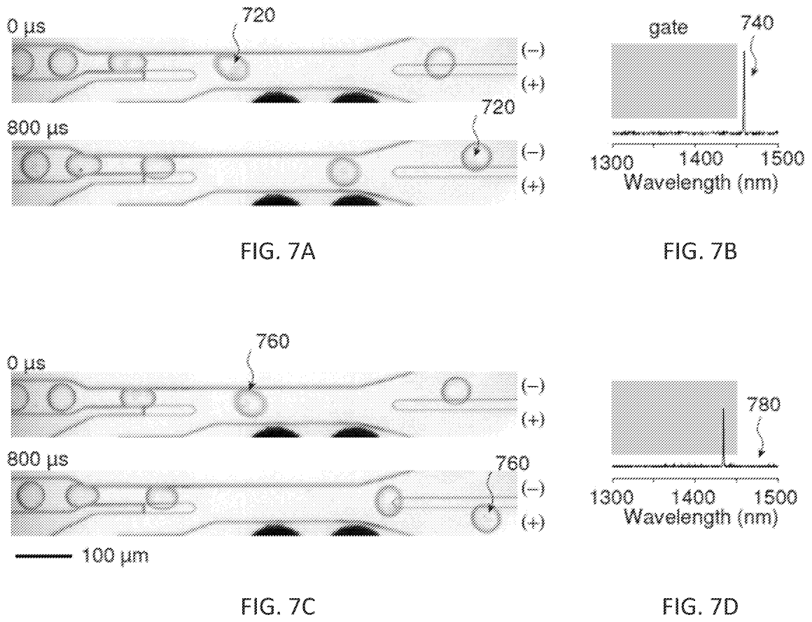

FIGS. 7A-7D demonstrate a non-limiting example of sorting based on spectral barcodes. First, a gating strategy for short-pass or long-pass wavelength sorting was tested. The spectrometer-linked FPGA was programmed to identify, in real time, the pixel of highest intensity each time a lasing event was registered. If this pixel corresponded to a wavelength within the sorting window, a high-voltage electric field was applied to the electrodes to deflect the traversing droplet toward the appropriate outflow channel. In cases in which more than one lasing peak emanated from a droplet, possibly because of the presence of two cells or a single cell with two LPs in the droplet, the gating condition was set such that the sorting signal is fired only if all the emission peaks fell within the sorting window. In the experiment, a short wavelength gating condition with a cutoff wavelength of 1450 nm was used. In FIG. 7A, cell 720 includes an LP whose emission spectrum 740 (FIG. 7B) is outside of the gating window. Accordingly, cell 720 is sorted into the (−) outlet. In contrast, cell 760 in FIG. 7C includes an LP whose emission spectrum 780 (FIG. 7D) falls within the gating window. Accordingly, cell760 is sorted into the (+) outlet.

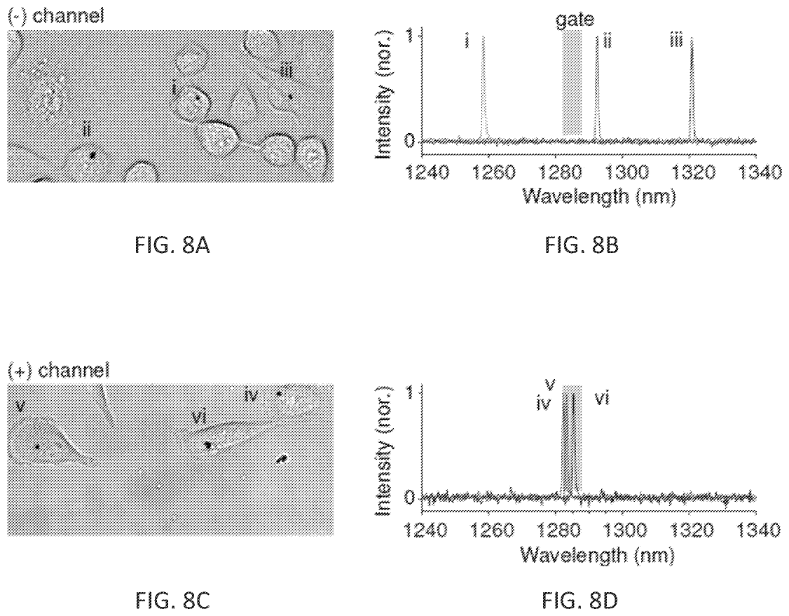

FIGS. 8A-D demonstrate a non-limiting example of band-pass sorting. A 5 nm-wide sorting window centered around 1285 nm was applied as the selection criterion. LPs obtained from a single semiconductor wafer with In_{0.75}Ga_{0.25}As_{0.54}P_{0.46} as active material was used, which covers a spectral range from 1245 to 1340 nm. The LPs were co-cultured with HeLa cells and flowed through the sorting chip. Cells collected from each outlet were re-plated on a culture well plate, and the LP emission from the cells were measured using the previously modified confocal microscope employing a high-resolution spectrometer. In this non-limiting example, the cells harvested from the (+) outlet contained LPs that predominantly lased at wavelengths within the predefined 5 nm window close to 1285 nm. The routing accuracy was consistent with that obtained in the above wavelength-independent binary sorting.

In this way, a subpopulation of cells associated with a specific tag color can be actively enriched. This can result in the isolation of cells marked with emitters of unrivaled spectral purity. In the above example, In_{0.75}Ga_{0.25}As_{0.54}P_{0.46} LPs and HeLa cells were used. The fluorescence emission of each LP obtained from measuring the spectra below pump threshold (˜10 pJ) was centered at 1275 nm with a FWHM of 70 nm. This low spectral purity leads to significant crosstalk that hinders multiplexed, multi-fluorescence measurements. Similarly, there is a large ˜100 nm spectral distribution of lasing wavelengths. The largescale fabrication of microdisk LPs via optical lithography naturally results in nanometer scale variations in cavity diameter, which arise due to minute processing inhomogeneities across the original semiconductor wafer's surface. Since a single nanometer increase in diameter roughly changes the emission wavelength by 1 nm within a given optical mode, the effect of any inhomogeneity introduced during LP fabrication effectively randomizes the emission wavelengths of LPs within a set.

The ±2.5 nm sorting window was used as reference data serving as the selection criterion or gating strategy. The spectrometer-linked FPGA was programmed to identify, in real time, the pixel of highest intensity each time a lasing event was registered. If this pixel corresponded to a wavelength within the sorting window, an electric field was once again used to deflect the traversing droplet toward the appropriate outflow channel. In cases in which more than one lasing peak was determined to have emanated from the same droplet, the droplet was only actively deflected if both emission peaks lased within the sorting window.

After 800 detection events of lasing occurring within the sorting window, the cells were re-plated after 4 h. Using a microscope modified by including a commercial spectrometer attachment, the LP emission from cells collected from each outlet were measured. A histogram of the recorded peak lasing wavelengths confirmed showed that the majority of LPs emitted at approximately 1285 nm. By contrast, measurements of LPs collected from the other outflow channel showed that these cells were tagged with LPs that lased across a far wider, 100 nm spectral bandwidth with a dearth LPs close to 1285 nm.

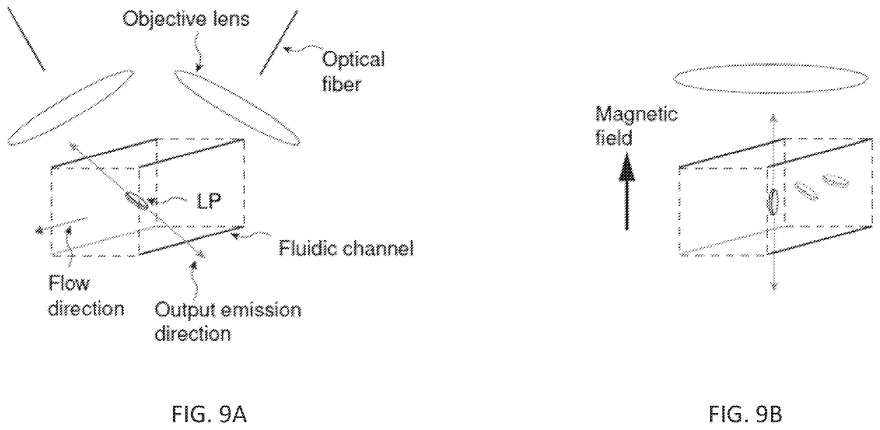

The emission intensity of certain types of LP, such as those of microdisk geometry, can vary significantly with angle. In the case of a microdisk LP, most of its laser emission is in the plane of the disk. This can make detection challenging when the orientation of the disk is flat within the microchannel (i.e., the disk faces are orthogonal to the optical axis of the collection optics). Several possible techniques to overcome this problem are possible. Firstly, a multi-axis collection optics may be used. In one embodiment, two or more collection objective lenses arranged at different angles may be used. In another embodiment, a single objective lens, followed by two or more fiber-optic collectors may be used. FIG. 9A demonstrates such a collection system with two optical fibers collecting light at two different angles. Three or more optical fibers may be used to collect the output emission from laser particles. These fibers are connected to the spectrometer with appropriate coupling optics. This arrangement ensures the detection of the laser emission from arbitrarily oriented microparticles with minimal intensity variation and maximal probability of detecting their lasing peaks for a given detection dynamic range of the spectrometer.

FIG. 9B shows an alternative technique. Magnetic microdisks have been demonstrated, for example, using a thin layer of magnetic material (e.g., permalloy). These disks exhibit a magnetic dipole moment that, when an external magnetic field is applied, results in the disk re-orienting to align its moment with the external field. This effect has been used to demonstrate manipulation of microdisk objects in fluid. Such a magnetic layer could be incorporated with an LP and an external magnetic field applied such that the disk aligns with the optical axis of the collection system as it flows.

Yet another technique would be to incorporate a highly scattering medium into the flow fluid. Liquids which support high degrees of scattering include those containing TiO₂ or intralipid. Usually, approximately 1% concentration of intralipid approximates the scattering features of brain tissue. By surrounding any flowing disks with a scattering solution, light can be redirected into the collection objective by redirecting light more uniformly across 47L steradians. To prevent unwanted interactions between the scatterers and the LP's optical mode, a coating such as silica could applied to surround the bare LP. Such a scattering fluid would likely also decrease the ability of the pump to penetrate to the LP. However, the peak signal of LP emission can quickly saturate such that harder pumping simply results in linewidth broadening, which may not contribute to increased signal-to-noise ratio in many detection systems. Therefore, at high flow speeds, collection efficiency effects likely dominate.

Other approach is using omnidirectional laser particles, which are engineered to have minimal angle dependent emission. Various methods to minimize the angle dependence have been known in the art, including coating laser particles with scattering nanoparticles.

Although microdisk laser particles are used in the examples, any types of laser particles known in the art may be employed, which include spherical bead microparticles and nanowires.

Droplet microfluidics offers a convenient technological platform that can be used to manipulate individual micro-objects. Aqueous micro-droplets surrounded by immiscible oil can be used to encapsulate these objects, trapping them inside the droplet and allowing them to be independently manipulated. Recently, a commercial droplet fluidic sorter (Onchip Biotechnologies) has been released which can be used to encapsulate and sort fluorescent objects as small as individual bacteria. Droplet-based sorting can also be used to manipulate individual LPs and cells.

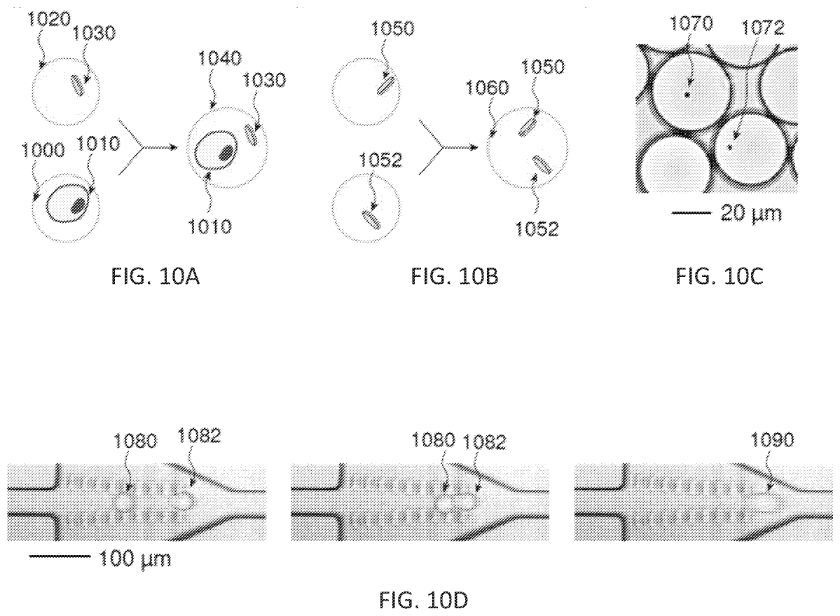

FIG. 10A illustrates an exemplary utility intended to produce droplets each of which contains only one cell or only one LP. For example, a droplet 1000 encapsulating a cell 1010 is fused with a droplet 1020 containing an LP 1030 to efficiently pair the two in a single droplet 1040. This utility can circumvent the limitation of random tagging that is subject to Poisson statistics.

FIG. 10B depicts another utility pairing of two LPs, 1050 and 1052, to produce a droplet 1060 containing the two LPs each. Further operations can clearly be used to produce droplets containing any specific number of LPs. By producing droplets containing a desired number of LPs, further fusion with a droplet containing a cell would deliver that precise number of LPs to the cell. FIG. 10C shows two droplets containing single microdisk InGaAsP LPs, 1070 and 1072.

Another exemplary utility is suited for forming multiplet-type laser particles. The captured LPs can then be attached through chemical means within the droplet. Such an operation would allow controllable formation of multiplets with a specific number of LPs. For example, a triplet (a multiplet comprised of three individual laser microparticles) could be formed by a droplet with a pair of LPs fusing with a droplet with only a single LP. A quartet multiplet could be formed by combining two droplets each of which contain two LPs.

Fusion of a pair of droplets can be performed using previously developed droplet fusion devices, which trap a ‘leading’ droplet between a narrow opening and allow a ‘following’ droplet to strike it. FIG. 10D shows the experimental result of the fusion of two droplets, 1080 and 1082, at successive timepoints, before, during and after fusion resulting in a fused droplet 1090. Microparticles remain encapsulated within individual droplets allowing them to remain stable over many hours, during which the droplets, and thus their contents can be manipulated.

Although a two-way sorting architecture with two collection channels is described, these embodiments can be extended to more than 2 collection channels. 4-way or 6-way sorters are commonly found in state-of-the-art commercial flow sorters. A myriad of scenarios for sorting cells and laser particles can be envisioned. For example, laser particles with a first spectral barcode may be routed to a first collection channel, while laser particles with a second barcode may be routed to a second collection channel, and so on.

Another embodiment of this invention is a sorter employing a re-circulator. One application of this embodiment is to divide a polychromatic set of LPs into multiple monochromatic batches. For example, the starting set of LPs span a 100 nm spectral window. Sorting them based on a ±2.5 nm spectral window, for example, could create 20 monochromatic batches from a single 100 nm spectral window. A smaller window, such as 1 nm, could produce a greater number of batches with identical lasing wavelengths within the 1 nm window.

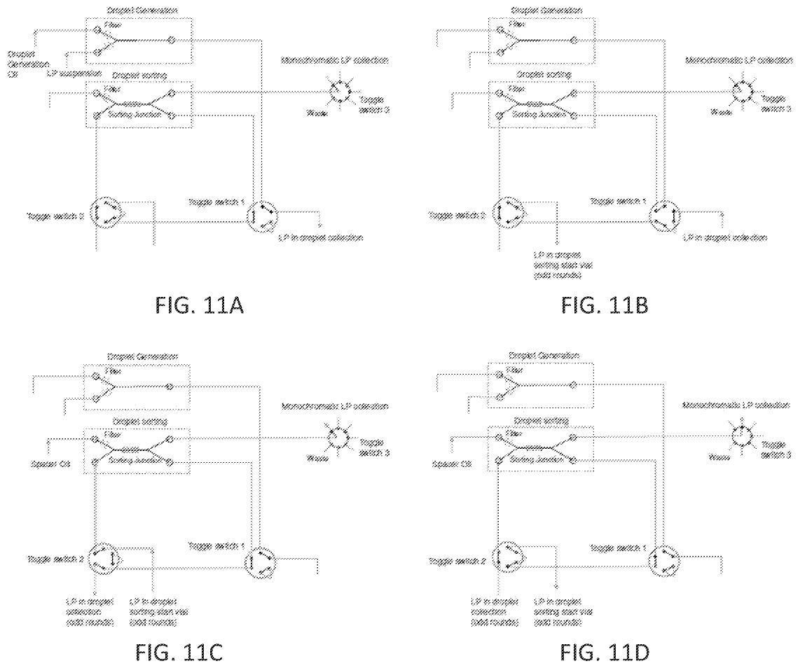

FIGS. 11A-11D illustrate the steps of a recirculating platform to perform this operation efficiently by recirculating the contents of one of the collection channels or outlets. While a dielectrophoretic droplet sorter is one possible sorting mechanism that could be applied, alternative sorting mechanisms, such as acoustic sorting, valve-based routing, and inertial separation, as well as other techniques known in the art, could be used. A droplet sorter has the advantage of preventing any sedimentation or any aggregation between LPs in separate droplets. FIG. 11A shows the first step of the automated production of monochromatic batches from a relatively polychromatic LP set. First, the LP suspension is injected into a droplet generation chip and collected. In the second step, a fluidic switch is toggled (toggle switch 1) that enables the LPs, now in droplets, to be moved into an alternative vial (FIG. 11B). A further toggle switch then injects the LPs into a sorting device, which isolates a monochromatic batch of LPs based on a user-specified reference spectral window (FIG. 11C). The LPs that are not sorted are once again re-collected. Finally, fluidic switch 2 is toggled, allowing the LPs to be reinjected into the sorting device. By toggling switch 3, a different batch of LPs can be collected based on a different spectral collection window (FIG. 11D). LPs not part of the new monochromatic batch are collected once again. The cycle then repeats from the step shown in FIG. 11i, until all monochromatic batches have been formed.

The above methods of sorting based on laser particles may be combined with conventional fluorescence flow cytometry techniques. LPs emitting at infrared wavelengths do not exhibit crosstalk with common fluorophores, making LPs compatible with established fluorescence-based technologies.

LP tags have been proposed as single cell sequencing probes, in which the emission signatures allow individual cells to be tracked through an RNA sequencing workflow to enable knowledge of each cell's spatial location to be tied to information regarding its genetic expression. In some single cell sequencing protocols, cells are commonly sorted prior to sequencing by traditional FACS to target a desired subpopulation to be sequenced. Similarly, binary LACS would be able to enrich for cells suitable for sequencing by selecting tagged cells. Wavelength-based LP sorting is expected to have more versatile use. For example, it allows specific cells identified from an imaging experiment to be isolated for further analysis.

LACS could be used to isolate cells based on their LP barcodes that have been previously identified by techniques such as microscopy or flow cytometry, that can associate individual cells with phenotypic features, such as protein-tagged fluorescence expression. By reading LP signatures at each step of a workflow, comprehensive cell profiles could be built and isolated as desired.

Besides cell sorting, the technology may be used to sort LPs, either with or without cells, inside droplets. Currently, LPs are fabricated such that each particle has a random wavelength, uniformly distributed over the gain bandwidth of the semiconductor. However, for some experiments it would be useful to be able to produce a batch of LPs with an identical wavelength, just like fluorophores with identical fluorescence spectrum. By repeated wavelength-selective sorting, batches of LPs at different colors could be created for various applications such as highly multiplexed cell-type labeling for in vivo imaging.

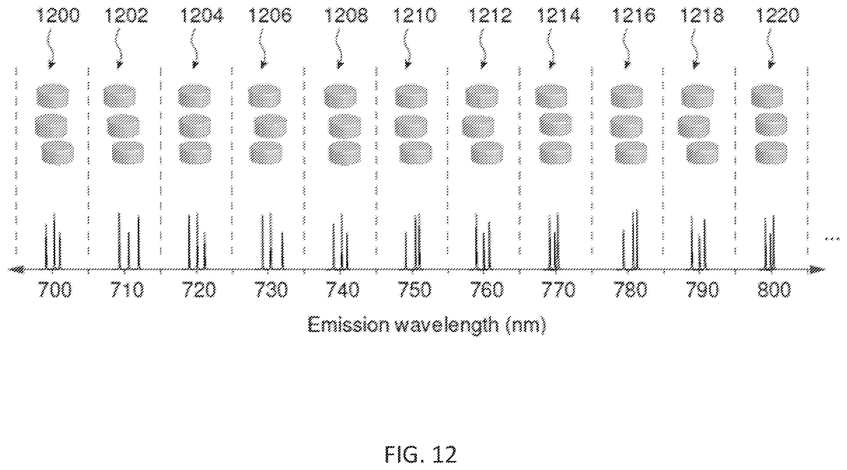

FIG. 12 illustrates an example of batch laser particles with substantially identical barcoding characteristics. A total of 11 batches of LP groups 1200 to 1220 are shown. For simplicity, only 3 particles per batch or group is presented, along with their emission spectra. Each particle is assumed to emit a single lasing peak. All the particles in the first group have laser peak wavelengths in 700+/−3 nm in this illustration. The second group is characterized by the peak wavelength in in 710+/−3 nm. The wavelength range of each group defines its barcoding characteristic. All 11 groups have distinctly different barcoding characteristics. The wavelength separation or window may be smaller than +/−1 nm.

Within each batch comprising of many particles, two or more laser particles may have nearly identical wavelengths not well differentiable. This is not a problem in many applications as long as particles from different groups are differentiated.

The example below provides further details of the fabrication of the LPs and microfluidic device and their use in the example disclosed above.

### Example

### Materials and Methods

### Fabrication and Transfer of LPs

Epitaxially grown wafers were used to produce LPs. The wafers were based on an InP substrate, with a 300 nm thick undoped InP buffer layer. On top of this layer, one or more 200 nm thick InGaAsP layers were grown with 300 nm separation between them. 2 μm thick SU8-2002 (MicroChem) photoresist was spun on the wafer surface followed by soft bakes for 1 min at 65° C. and 2 min at 95° C. The wafer was exposed through a chrome on quartz mask comprised of a hexagonal array of circles, using an i- and h-line mercury arc lamp and with a dose of 60 mJ cm-2 (Karl Suss MJB4 mask aligner). After this, further 1 min bakes at 65° C. and 95° C. were performed followed by development in SU8 developer (MicroChem). A 10 min hard bake on a 190° C. hotplate was then performed after which the wafer was descummed using an O2 plasma (Anatech Barrel SCE 160). The remaining circular photoresist features were then used as a mask to dry etch columns into the wafer with ICP-RIE using chlorine chemistry (Oxford Instruments PlasmaPro 100 Cobra 300). The remaining SU8 was then removed using a cleaning sequence comprised of a 3 min plasma clean using CF4 and O2 (Oxford Instruments PlasmaPro 100 Cobra 300), a 30 s dip in 1:1 H2SO4:H2O and a final O2 plasma clean (Matrix 105). Microdisk LPs were then released from the substrate by dissolving the InP supports using 3:1 HCl:H2O for 30 s. The LPs were then washed at least 3 times in deionized water through repeated rounds of centrifugation and removal of the supernatant. LPs suspended in water were then added to cells followed by the appropriate amount of 10×PBS to maintain an isosmotic solution.

Microfluidic device fabrication Poly(dimethylsiloxane) (PDMS) microfluidic devices were created using an SU8-on-silicon master mold. To create this mold, a two-layer device mold was created. The first layer consisted of the sorting divider and channels separating the sorting outflow tracts that allowed for pressure equalization. To create this layer, SU8-3010 (Kayaku Advanced Materials) was spun at 3000 rpm onto a Si wafer (UniversityWafer) and then soft baked for 5 min at 95° C. The first layer of the pattern was then exposed using a 2500 mJ cm-2 365 nm wavelength laser writer (Heidelberg Instruments MLA150). A 95° C. post exposure bake was then performed for 5 min followed by a 5 min development in propylene glycol methyl ether acetate. The second layer defined the microfluidic flow channels and the electrode channels. To form this layer, the process was repeated but with SU8-3025. The laser writer was used to write the pattern in a manner that aligned it to the first layer. The master mold was then placed inside a vacuum chamber for 30 min with a drop of 1H,1H,2H,2H-perfluorooctyltrichlorosilane (Oakwood Chemical) and then baked for 1 min at 180° C. This prevented PDMS from sticking to the mold too firmly. Next, a 10:1 base elastomer: curing agent PDMS mixture (Sylgard 184 Silicone Elastomer Kit) was poured onto the mold and allowed to cure at 65° C. for 2 h. After this, the molded PDMS was peeled off the wafer. A 1.2 mm diameter biopsy punch (Harris Un1-Core) was then used to create holes in the PDMS for each of the 3 inlets, 2 outlets, and 4 electrode openings. The PDMS was then bonded to a glass slide substrate using O2 plasma bonding (Plasma Etch) and baked at 70° C. for 2 h to further strengthen the bonding. At each flow channel inlet and outlet, 1/16″×0.006″ OD×ID PTFE tubing (Valco Instruments) was connected. For the tubing linked to the inlets, pressure pumps were connected to the other end (Fluigent Flow EZ), along with an inline flow meter (Fluigent Flow Unit). Aquapel (Pittsburgh Glass Works) was flowed into the device to render the glass surface hydrophobic. After sitting for 30 s, this was rinsed by flushing the devices with FC-40 and dried using an N2 air gun. To create electrodes, the microfluidic device was placed on a hot plate at 80° C., and low melting point In51Bi32.5Sn16.5 solder (Indium Corporation Indalloy) was fed into one of the openings into the live electrode channel and one of the openings into the ground electrode channel. Whilst still on the hotplate, gold connects (Digi-Key 87224-1) were placed into each of the two openings. UV-curable adhesive (Loctite 352) was used to strengthen the connection between the PDMS and the gold connect.

### Cell Culture

HeLa cells (ATCC) were cultured in a solution comprised of Dulbecco's modified Eagle medium, 10% (v/v) fetal bovine serum (FBS) and 1% (v/v) penicillin-streptomycin. For LP imaging experiments, LPs were added directly to the cell culture along with the requisite quantity of 10×PBS to ensure isotonicity. After 24 h, cells now with internalized LPs were removed from the plate by first washing the culture three times in PBS, incubating (Thermo Scientific Heracell 240i) for 5 min in TrypLE Express Enzyme (Fisher Scientific). Next, the now suspended cells were taken from the culture plate and run through a 40 μm strainer (MTC Bio SureStrain Premium Cell Strainers) to remove any cell clumps. An excess of media was then run through the strainer to prevent individual cells from sticking to the mesh. Centrifugation was then used to pellet the cells and the supernatant was aspirated. Cells were then resuspended in a solution of 79% cell media, 17% OptiPrep (Sigma Aldrich), 1.28% Dnase I (Thermo Scientific), and 2.55% Dnase reaction buffer (Thermo Scientific). The OptiPrep prevented cells from sedimenting during the flow experiment and the Dnase minimized cell clumping caused by free DNA strands. Following sorting experiments, cells were recovered from droplets surrounded by oil by adding approximately twice the droplet volume of Pico-Break 1 (Sphere Fluidics) to the collection tube and leaving the mixture to sit on ice for 1 min. The top solution was then gently pipetted up and down. This caused the droplets to lyse, leaving a two-layer liquid with oil on the bottom and cell media containing cells on the top. Next, an excess of cell media containing 20% OptiPrep was added. The collection tube was then centrifuged at 100 g for 5 s to better delineate the interface between the oil and the aqueous suspension of cells. The addition of optiPrep minimized the likelihood of cells being pinned to the oil-aqueous interface. The top layer was then carefully removed, pipetting this layer into a clean centrifuge tube. An excess of OptiPrep-free cell media was then added to this tube, diluting the OptiPrep and allowing the cells to be pelleted by centrifugation. Following pellet formation, the supernatant was aspirated and replaced with fresh media. The cells could then be re-plated on a glass bottom well for further imaging and characterization.

### Cell Sorting Experiments

A microfluidic device was placed atop a microscope stage. The microscope was equipped with a high-speed camera (Integrated Design Tools M3), a pump source to excite LPs and a home-built spectrometer to measure lasing output. The pump laser focus was positioned adjacent to the sorting junction. Of the three input flow channels, one was connected to an aqueous reservoir comprised of LP-tagged cells. The other two were filled with droplet generation oil (Bio-Rad QX200 Droplet Generation Oil). Flow was driven using pressurized sources (Fluigent Flow EZ) and velocity controlled by flow meters (Fluigent Flow Unit) with closed loop feedback. The two outflow channels were each connected to collection tubes. Flow speeds were first set at 35 μL min⁻¹ into the spacer inlet, 5 μL min⁻¹ into the oil generation inlet, and 2 μL min⁻¹ for the aqueous cell solution. This resulted in the generation of droplets containing tagged cells. These droplets were then spaced by oil from the spacer inlet, enabling a single droplet to be sorted at a time. The flow speeds were then tuned to achieve the correct timing by using the high-speed camera to monitor droplet flow patterns. One end of the live electrode and one end of the ground electrode was then connected to a high-voltage amplifier (TREK Model 2210-CE) via crocodile clips. The amplifier amplified a square wave train emanating from a DAQ card (National Instruments PCIe-6321), that was triggered by a pulse sent from an FPGA (National Instruments PCIe-1473R) when the appropriate sorting condition was met. Optical measurements LP emission during flow was collected by pumping LPs using a 10 ns pulse width at 1064 nm with 2 MHz repetition rate (CNILaser FL-1064-Nano-LAB). Excitation light was focused using a 10×0.3 NA objective (Leica HC PL FLUOTAR). Emission light was collected and dispersed using a custom-built grating spectrometer equipped with a linescan camera (Sensors Unlimited 2048 L). This camera was connected to an FPGA (National Instruments PCIe-1473R) that determined whether sorting criteria were met. Sorting accuracy was assessed by comparing the flow device inputs and outputs using a confocal microscope (Olympus Fluoview 3000). This microscope was able to attain brightfield images of cells and LPs and was equipped with a cell incubator (Tokai Hit). Furthermore, the microscope was modified to measure LPs using a 1060-1070 pump laser operating at 2 MHz with 10 ns pulse width (Spectra Physics VGEN-ISP-POD). Spectra were collected by a 20×0.45NA objective (Olympus IMS LCPLN20XIR) and sent to a spectrometer (Andor Kymera 328i) equipped with a linescan camera (Sensors Unlimited 2048 L). All camera data was saved and analyzed using custom code based on MATLAB and Python.

The present invention has been described in terms of example embodiments, and it should be appreciated that many equivalents, alternatives, variations, additions, and modifications, aside from those expressly stated, and apart from combining the different features of the foregoing versions in varying ways, can be made and are within the scope of the invention. While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the disclosures described herein can be embodied within a form that does not provide all of the features and benefits set forth herein, as some features can be used or practiced separately from others. The scope of certain disclosures disclosed herein is indicated by the appended claims rather than by the foregoing description. All changes which come within the meaning and range of equivalency of the claims are to be embraced within their scope.

1. A flow sorter comprising:
a sample loader that is configured to receive a sample that contains one or more laser microparticles, wherein each laser microparticle is configured to generate laser emission with one or more distinct spectral peaks when excited;
a spectrometer receiving the laser emission from the one or more laser microparticle and generating spectral data;
a processor configured to receive the spectral data and generate a sorting signal; and
a switch configured to receive the sorting signal and route the one or more microparticles to a particular one of multiple collection channels based on the sorting signal.

2. The flow sorter of claim 1, further comprising a database containing reference data, wherein the sorting signal is generated based on the comparison between the reference data in the database and the spectral data generated by the spectrometer.

3. The flow sorter of claim 1, further comprising an excitation source and a photodetector configured to detect fluorescence from the sample.

4. The flow sorter of claim 1, wherein the one or more laser microparticles are coupled to cellular entities.

5. The flow sorter of claim 1, wherein the one or more laser microparticles in the sample are encapsulated in at least one emulsion droplet.

6. The flow sorter of claim 1, wherein the switch includes one of a mechanical, electrostatic, or valve-type actuator.

7. The flow sorter of claim 1, wherein the spectrometer has an optical resolution of less than 1 nm.

8. The flow sorter of claim 1, wherein the one or more laser microparticles are comprised of semiconductor disk lasers.

9. The flow sorter of claim 1, further comprising a magnetic field generator configured to apply a magnetic field to the one or more laser microparticles.

10. The flow sorter of claim 1, further comprising multiple optical fibers configured to receive the laser emission from the one or more laser particles in different directions and transmit the laser emission to the spectrometer.

11. The flow sorter of claim 1, wherein the processor is configured to control the switch to route microparticles having substantially similar barcoding characteristics in their spectral data to a common one of the collection channels.

12. The flow sorter of claim 11, wherein the barcoding characteristics include at least one of a wavelength and a number of the laser emission.

13. The flow sorter of claim 11, wherein the processor is configured to control the switch to route laser microparticles having substantially identical lasing peak wavelength to a common one of the collection channels.

14. The flow sorter of claim 1, wherein the processor is configured to control the switch to route laser microparticles having one or more substantially different barcoding characteristics in their spectral data, compared to the one or more laser microparticles routed to a different collection channel of the multiple collection channels.

15. The flow sorter of claim 1, further comprising a re-circulator configured to feed the one or more laser microparticles routed to the sample loader.

16. A method of sorting laser microparticles comprising:
loading a sample that contains one or more laser microparticles into a microfluidic system;
exciting the one or more laser microparticles to cause each of the one or more laser microparticles to generate laser emission;
analyzing a spectrum of the laser emission to determine characteristics of the laser emission of each of the one or more laser microparticles;
as each of the one or more laser microparticles progresses through the microfluidic system, sorting the one or more laser microparticles based on the characteristics to route each of the one or more laser microparticles with predetermined spectral characteristics to a common outlet of the microfluidic system.

17. The method of claim 16, wherein each of the one or more laser microparticles is coupled to a cell.

18. The method of claim 16, wherein the one or more laser microparticles in the sample are encapsulated in at least one emulsion droplets.

19. The method of claim 16, wherein the characteristics include lasing peak wavelength.

20. The method of claim 16, further comprising applying a magnetic field to each of the one or more laser microparticles progresses through at least a portion of the microfluidic system.
